(19) United States
(12) Patent Application Publication
(10) Pub. No.: US 2018/0204064 A1
(43) Pub. Date: Jul. 19, 2018

(54) METHOD AND SYSTEM FOR ANNOTATING VIDEO OF TEST SUBJECTS FOR BEHAVIOR CLASSIFICATION AND ANALYSIS

(71) Applicant: Adrienne Rebecca Tran, Melbourne, FL (US)

(72) Inventor: Adrienne Rebecca Tran, Melbourne, FL (US)

(21) Appl. No.: 15/409,979

(22) Filed: Jan. 19, 2017

(51) Int. Cl. G06K 9/00; G11B 27/34; G06F 3/0484; G06K 9/62; G06F 17/30

(52) U.S. Cl. CPC G06K 9/00718; G11B 27/34; G06F 3/04847; G06F 17/30858; G06K 9/6267; G06F 17/3082; G06K 9/6227

(57) ABSTRACT

An annotation tool and method of annotating video of test subjects is disclosed. The method and tool includes a user interface having a timeline section configured to display a plurality of frames progressively of a video, a video player section configured to play a video, and a label section having a plurality of behavior classification labels and label application controls. The timeline section further has a cursor indicating a current frame of video playing in the video player. Activation of a particular label application control applies a particular behavior classification label at a current position of the cursor on the timeline of the video. The tool and method further includes a server module for handling static and API requests from the user interface and a database for storing video and annotated video. The server facilitates storage and retrieval of video and annotated video between the user interface and the database.

### BACKGROUND

### 1. Technical Field

This disclosure relates generally to annotating video footage and more specifically to a method and system for annotating video footage of test subjects for behavior classification and analysis.

### 2. Background of the Related Art

Behavioral analysis of test subjects is a process that is a bottleneck in many areas of science, but especially in biomedical research. Because of the difficult nature of classifying behaviors, humans are currently vital to the data gathering process. In the present methodologies, researchers typically watch many hours of footage and/or comb through many pages of records, which is an error prone and laborious process that is still central to biomedical experiments. The research time expended to analyze subject video is on the order of 25 to 1. For example, it currently takes on average twenty five minutes of human analysis to analyze one minute of mouse behaviors. With the experiments in the lab there are typically several dozen streams of continuous footage being recorded, generating far too much data for human research personnel to process in a reasonable time.

Deep computer learning models have been developed to perform video analysis at human levels of proficiency. In these models it takes approximately twelve seconds to process one minute of video, indicating there is great opportunity for computer analysis and automation in this area. To truly leverage the power of new deep learning models, the systems require very large training datasets, such as the popular ImageNet database which contains over fourteen million images in twenty one thousand categories.

Unfortunately, there no existing tools which are effective at annotating behaviors in videos for the purpose of training these deep learning models. Most video annotation interfaces are focused on object classification, which make them ill-suited for the wide range of interactions and experiment setups that behavioral analysis requires. In particular, these tools often show only a single frame of video at a time, making them ill-suited to classifying behavior that involves motion.

Accordingly, there is a critical need in the industry for a video annotation tool that is configured for annotating identifiable behaviors of test subjects in experiment video where the annotations are particularly suitable for training deep learning models.

### SUMMARY

The present invention provides a unique and novel video annotation tool and a method of annotating video of test subjects that includes a user interface having a timeline section configured to display a plurality of frames progressively of a video, a video player section configured to play a video, and a label section having a plurality of behavior classification labels and label application controls. The timeline section further has a cursor indicating a current frame of video playing in the video player. Activation of a particular label application control applies a particular behavior classification label at a current position of the cursor on the timeline of the video. The annotation tool and method further includes a server module for handling static and API requests from the user interface and a database for storing video and annotated video. The server facilitates storage and retrieval of video and annotated video between the user interface and the database.

The annotation tool allows researchers to gather data to train deep learning models of neural networks. The web-based annotation system also lets users from all over the world stream videos and detail what is happening on a frame by frame basis. While still much slower than a computer model, the annotation tool has noticeably improved the speed at which human annotators can process videos, thereby increasing the speed at which the deep learning models of a neural network can be trained.

The system and method has proved generic enough to work for multiple types of projects: ecologists annotate interactions between birds in the wild, neuroscientists analyze eye-tracking data from epileptic patients, and biomedical researchers classify behaviors in mice using the web interface.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present invention will become better understood with reference to the following description, appended claims, and accompanying drawings where:

FIG. 1 is an illustration of a system for annotating video of test subjects for behavior classification and analysis;

FIG. 2 is an illustration of a user interface of the a system for annotating video of test subjects for behavior classification and analysis, illustrating a first step of annotating video of test subjects;

FIG. 3 is an illustration of a user interface of the a system for annotating video of test subjects for behavior classification and analysis, illustrating a second step of annotating video of test subjects;

FIG. 4 is an illustration of a user interface of the a system for annotating video of test subjects for behavior classification and analysis, illustrating a third step of annotating video of test subjects;

FIG. 5 is an illustration of a user interface of a system for annotating video of test subjects for behavior classification and analysis, illustrating a fourth step of annotating video of test subjects;

FIG. 6 is an illustration of close-up view of annotated video, showing the classification labels applied to the annotated video; and

FIG. 7 is an illustration of output source log file of the annotations made to the annotated video.

### DESCRIPTION OF THE PREFERRED EMBODIMENT

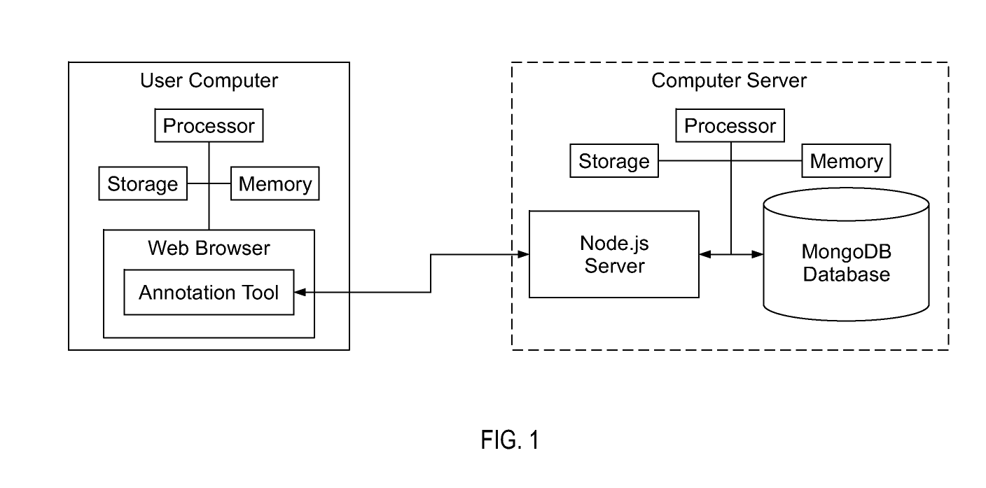

Referring now to FIG. 1, an embodiment of the method and system for annotating video of test subjects for behavior classification and analysis is shown generally. The system generally includes of three main parts: a user interface, a server that handles API and static file requests, and a central database to store all of the original raw video and annotated video.

The server may be a node.js server operating on a general purpose computer that has a processor, storage and memory. However, other configurations may be used and the number of servers may be replicated to support a high volume of transactions if desired.

The database may be a no-SQL database, such as MongoDB database. However, other database systems and architectures may be used. The database may operate on the same or a different computer as the node.js server. The database may also be split or distributed across multiple computers for truly high volume of data, as is known in the art.

To interact with the system, a user interface is provided, which will be described in greater detail below. The user interface may be configured to run in web browser software running on a general purpose computer that has a processor, storage and memory. The user interface could be written in javascript, for instance, and could include one or more libraries such as jQuery. However, other libraries and frameworks could be used such as React or Angular, for instance. Moreover, the annotation tool user interface may also be implemented in other languages and run as a stand-alone program, as is known in the art. The user interface may also be configured to operate on other computation hardware, such as a tablet computer, laptop computer or smartphone, for instance. Moreover, the user interface component of the annotation tool may communicate over the internet, allowing the database and any deep learning models to be set up and operate remotely from the user interface.

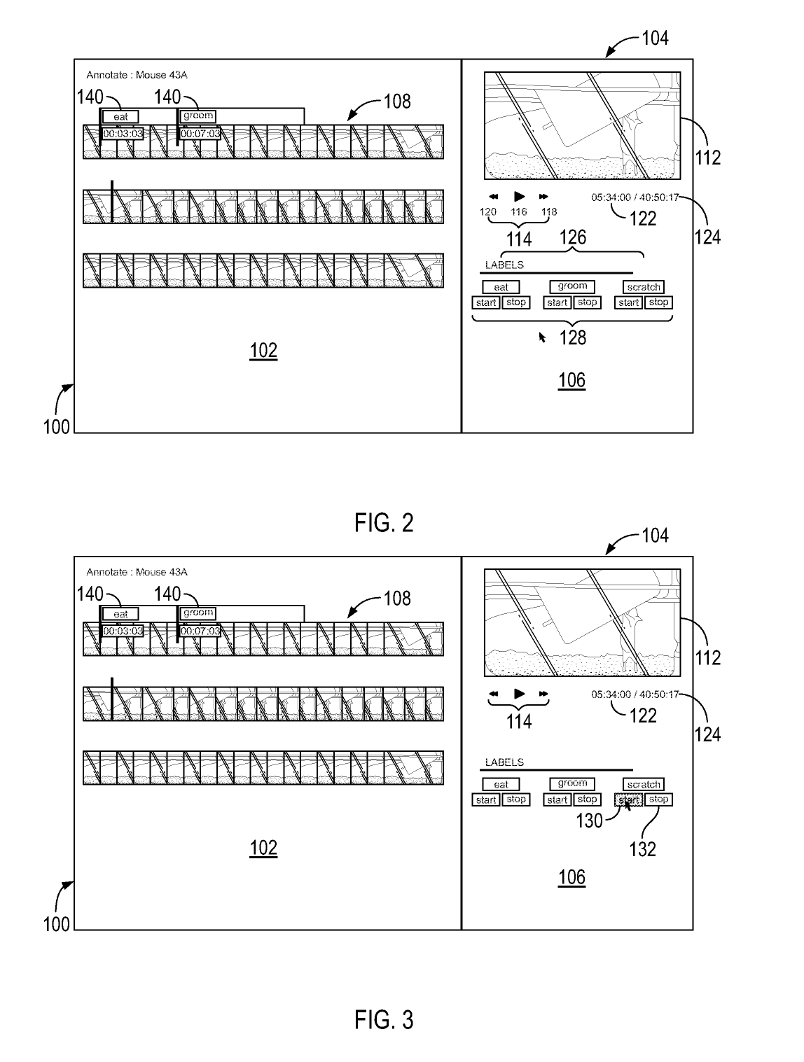

Referring now to FIG. 2, the user interface for the annotation tool is shown generally at 100. As noted above, the user interface may be web-based and implemented in a browser or modified browser software. The user interface is generally sectioned into three user areas, including a timeline area 102, a video player area 104, and a labels area 106.

The timeline area 102 includes the video shown in a series of frames 108 over the length of the video. A cursor 110 marking the current position of video playback in from the video player area 104 is provided to aid the user in behavior classification. Because the user can view multiple frames of video in a timeline format, the user can more readily identify motion-based behaviors that are desired to be classified.

The video player area 104 includes a video player window 112; playback controls 114, including play/pause 116, fast forward 118 and rewind 120; and a current time position 122 and total time 124 of the video. Playing, fast forward or rewinding the video causes the cursor 110 to traverse the timeline of segmented video frames 108 in the timeline area 102.

The label area 106 includes a number of behavior classifications 126 and associated functions 128 for applying a label to the video. In particular, start and stop function buttons 130, 132 are provided for each behavior classification 126. Although behavior classifications 126 for “eat”, “groom” and “scratch” are illustrated, it is to be understood that any desired behavior classifications may be listed, including, for instance,“drink”,“eathand”,“hang”, “rear”,“rest”,“sniff”, and “walk”, for mice. These behaviors may vary depending upon the study being conducted and the species of test subject being observed. The behavior classifications for fish, birds and insects will, accordingly, be different.

Referring to FIG. 3, once the user identifies a desired behavior, the user will click on the start function button 130 for that behavior. In the example shown, the user has clicked on the start function button for the “scratch” behavior. Clicking on the start button 130 marks the video at the current cursor position 110 with a start tag 136, including a label 140 with the identified behavior.

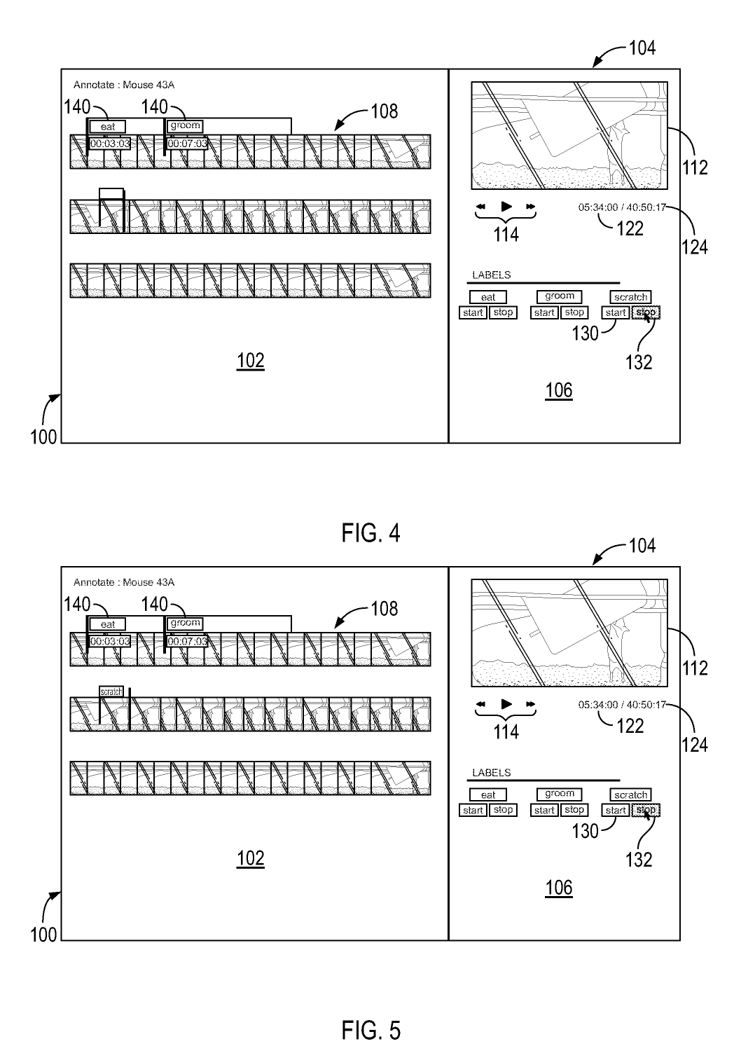

Referring to FIG. 4, the user then identifies when the test subject ceases the identified behavior. As the video playback progresses, a flag 138 will extend from the start tag 136 to the current cursor position 110.

Referring to FIG. 5, once the user has identified when the test subject has ceased the identified behavior, the user then clicks the end function button 132, which completes the label annotation for the video.

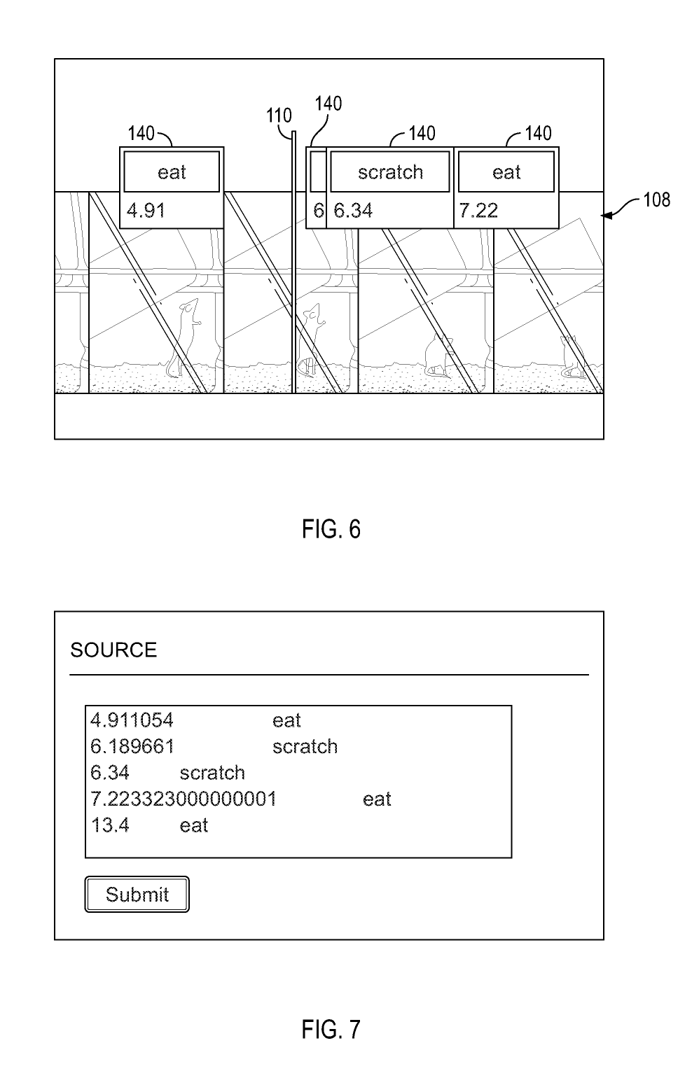

As shown in FIG. 6, the annotated video may include any number of identified behavior classification labels 140, which may also overlap in time. For instance, a test subject may groom and scratch simultaneously. As can be seen, each label 140 includes the classified behavior and the start time of the behavior.

Once the video is annotated, the user may then store the annotated video to the database.

Referring to FIG. 7, besides retrieving and playback of video or annotated video, the annotation tool may also export a log of times and classified behaviors for each annotated video in a desired format, such as JSON, CSV, TSV, and/or XML, for instance.

Once the sufficient video of test subjects is annotated with behavior classifications, it is then possible to train a neural network to identify and classify the desired behavior classifications, which eliminates the need for human annotators. The annotated video is inputted into the neural network, which is able to learn which position, movements, shapes of the test subject correspond to the behaviors classifications that have been previously annotated by human observers with the annotation tool system and method described herein. As a result, a deep learning model neural network may be trained with a high degree of accuracy that meets or exceeds the capabilities of human observers. Furthermore, the unique timeline view permits annotation of motion-based behaviors.

It would be appreciated by those skilled in the art that various changes and modifications can be made to the illustrated embodiments without departing from the spirit of the present invention. All such modifications and changes are intended to be within the scope of the present invention.

What is claimed is:

1. A video annotation tool for annotating video of test subjects for behavior classification and analysis, comprising:
a user interface having a timeline section configured to display a plurality of frames progressively of a video, a video player section configured to play a video, the timeline section further having a cursor indicating a current frame of video playing in the video player, and a label section having a plurality of behavior classification labels and label application controls, wherein activation of a particular label application control applies a particular behavior classification label at a current position of the cursor on the timeline of the video;
a server module for handling static and API requests from the user interface; and
a database for storing video and annotated video;
wherein the server facilitates storage and retrieval of video and annotated video between the user interface and the database.

2. The video annotation tool of claim 1, wherein the server module comprises a node.js server.

3. The video annotation tool of claim 1, wherein the database comprises a no-SQL database server.

4. The video annotation tool of claim 3, wherein the database comprises a MongoDB database server.

5. The video annotation tool of claim 1, wherein the label application controls comprise a start button configured to apply a start label for a particular behavioral classification at the current cursor position on the timeline of the video.

6. The video annotation tool of claim 1, wherein the label application controls comprise an end button configured to apply an end label for a particular behavioral classification at the current cursor position on the timeline of the video.

7. The video annotation tool of claim 1, wherein the behavior classification labels are selected from the group consisting of, drink, eathand, eat, groom, hang, rear, rest, sniff, and walk.

8. The video annotation tool of claim 1, wherein the user interface is configured to run in a web browser software.

9. The video annotation tool of claim 8, wherein the user interface comprises code written in javascript.

10. The video annotation tool of claim 9, wherein the under interface comprises a jQuery library.

11. A method of annotating video of test subjects for behavior classification and analysis, comprising:
selecting a video having footage of a test subject;
viewing a timeline of the video;
identifying a behavior of the test subject desired to be classified;
marking the start time of the identified behavior on the video with a label including the behavior classification; and
storing the annotated video.

12. The method of claim 11, further comprising marking the end time of the identified behavior on the video.

13. The method of claim 11, further comprising exporting a log of times and identified behaviors from the annotated video.

14. The method of claim 11, further comprising training a neural network to identify classified behaviors with a plurality of annotated videos.

15. The method of claim 11, wherein the test subjects are selected form the group consisting of mice, fish and crickets.

16. A method of training a neural network to identify behaviors in test subjects, comprising:
annotating a plurality of videos with behavior classifications of the test subjects, including a label with a start time and identified behavior creating a plurality of annotated videos;
inputting the plurality of annotated videos into the neural network;
whereby the neural network identifies a correlation between the identified behaviors classifications and video footage of the test subject.

17. The method of claim 16, wherein the test subjects are selected form the group consisting of mice, fish and crickets.

18. The method of claim 16, wherein the step of annotating a plurality of videos comprises:
selecting a video having footage of a test subject;
viewing a timeline of the video;
identifying a behavior of the test subject desired to be classified;
marking the start time of the identified behavior on the video with a label including the behavior classification; and
storing the annotated video.

19. The method of claim 18, further comprising marking the end time of the identified behavior on the video.

20. The method of claim 18, further comprising exporting a log of times and identified behaviors from the annotated video.
